(19) United States
(12) Patent Application Publication
(10) Pub. No.: US 2023/0118377 A1
(43) Pub. Date: Apr. 20, 2023

(54) Vanity Mirror

(71) Applicant: Johnny Justin Postles, Memphis, TN (US)

(72) Inventor: Johnny Justin Postles, Memphis, TN (US)

(21) Appl. No.: 17/474,969

(22) Filed: Oct. 14, 2021

(51) Int. Cl. A47G 1/16; F21V 33/00

(52) U.S. Cl. CPC A47G 1/16; F21V 33/004

(57) ABSTRACT

The present invention involves the use a mirror for vanities, such as maintenance of personal care. The mirror includes an arm attaching it to a base member, a flexible arm attaching the base member with a light source, and a base extension attaching to the base member. A user of the mirror of the present invention is able to adaptively light surfaces, such as the face or scalp, to better maintain their personal image.

### TECHNICAL FIELD

The presently disclosed subject matter relates to the field of mirrors for vanities.

### BACKGROUND OF THE INVENTION

The use of mirrors to observe personal appearance is a long practiced human activity. Personal appearance is maintained with the use of mirrors. Mirrors are used with cosmetic and shaving goods. Despite the need for mirrors for maintenance of personal appearance, there exist issues with mirrors when used for personal care. Mirrors must be used with lighting for reflection of image. A user of a mirror who cannot achieve a clear reflection of their image is hindered in maintain a personal image. Consequently, a new and improved mirror with the ability to adaptively light personal care activity would be advantageous in the art of vanity mirrors.

### SUMMARY OF THE INVENTION

The inventive subject matter includes: a mirror for personal care comprising: a mirror; an arm attached to the mirror; a base member, wherein the arm is attached to the base member; a light source; a power source attaching to the light source; a flexible-arm attached to the light source, wherein the flexible-arm attached to the base member, wherein the flexible-arm is made of a substantially pliable material; and a base extension attached to the base member.

The inventive subject matter further includes: A method of manufacturing a mirror for personal care comprising: forming a mirror; forming an arm attachable to the mirror; forming a base member, wherein the arm is attachable to the base member; forming a flexible-arm attachable to a light source, wherein the flexible-arm is attachable to the base member, and wherein the flexible-arm is made of a substantially pliable material; and forming a base extension attachable to the base member.

The inventive subject matter further includes: a kit for assembling a mirror for personal care comprising: a base member; an arm attachable to a base member; a mirror attachable to the arm; a one or more flexible arm, wherein the flexible-arm is made of a substantially pliable material and attachable to the base member; and instructions for building a vanity mirror.

### BRIEF DESCRIPTION OF THE DRAWINGS

FIG. 1 is a first view of an embodiment of the present invention.

FIG. 2 is a second view of an embodiment of the present invention.

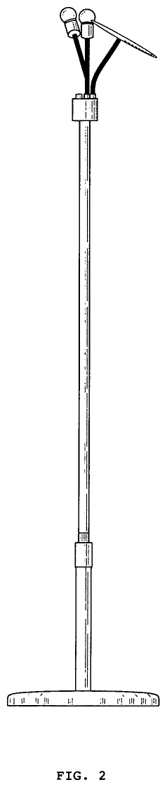

FIG. 3 is a third view of an embodiment of the present invention.

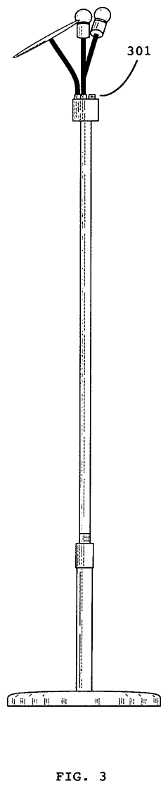

FIG. 4 is a fourth view of an embodiment of the present invention.

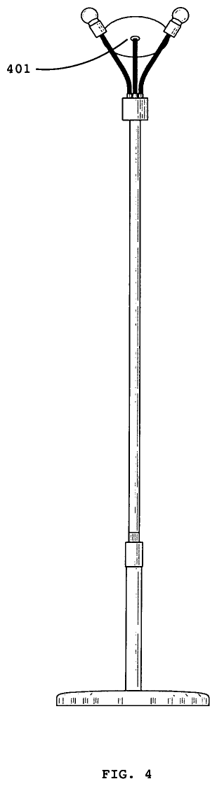

FIG. 5 is a top view of an embodiment of the present invention.

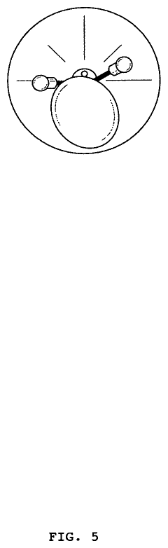

FIG. 6 is a bottom view of an embodiment of the present invention.

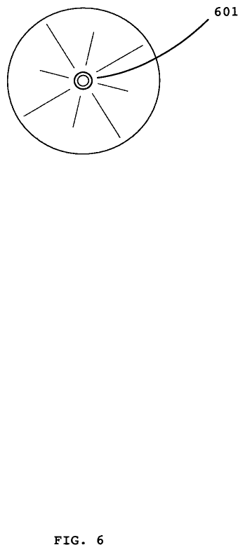

### DESCRIPTION OF EXEMPLARY EMBODIMENTS

The present invention involves the use a mirror for vanities, such as maintenance of personal care, wherein the mirror includes an arm attaching it to a base member, a flexible-arm attaching the base member with a light source, and a base extension attaching to the base member. A user of the mirror of the present invention is able to adaptively light surfaces, such as the face or scalp, while maintaining their personal image. Adaptive lighting can improve maintenance of personal image. Improved maintenance can lead to better health outcomes, such as a avoiding skin irritation, to reduce to chance of skin rashes, like folliculitis. There is a demand for a new and improved adaptively lit mirror vanity mirrors when personal image is being maintained, this may include homes, stores, and saloons.

The present invention includes a vanity mirror for support on a desk, table, or the floor. Consequently, the base of the vanity mirror have differences in height according to the surface in which the vanity mirror is intended to be placed. Preferred sizes are not to be construed as exact or limiting to the present invention.

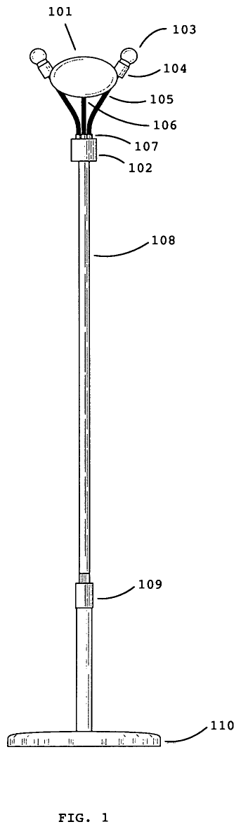

Now referring to FIG. 1, is one view of one embodiment of the present invention showing the vanity mirror with a height relative for placement on floor. A mirror 101 is shown in the figure, the mirror 101 can be flat or elliptical. The mirror 101 is large enough so that a user may see a reflection of an area of the body for personal maintenance, while being of a size minimal enough to be supported by the surrounding structure. A preferred mirror 101 is 11.5 in height by 9.5 in width. A base member 102 is attached by an arm 106 to the mirror 101. A preferred base member 102 is 2.5 inch diameter and 2.25 inch height. The mirror 101 is attached to the arm 106 by screwing, clipping, or physical combined and may include a mirror attachment 401 for aiding the attachment of the mirror 101 to the arm 106.

A light source 103 is shown as a light bulb and a light socket 104. The light source 103 can be an LED light, fluorescent or incandescent bulb, or other electrically powered light source. Not all light sources 103 will require a light socket 104. A preferred light source 103 is a light bulb and light socket 104. Light source 103 can be powered by conventional means including batteries and wires.

A flexible-arm 105 is shown attaching the light source 103 to the base member 102. The flexible-arm is substantially pliable in one regard because it can generally, and preferably, bend around 220 degrees at its midpoint. The flexible-arm is also substantially pliable because other points such as in between the midpoint and its ends, the flexible-arm is capable of bending 180 degrees. The arm 106 attaching the mirror 101 to the base member 102 may be rigid or a pliable arm similar to the flexible arm 105. The base member includes a structure, such as a base member socket 107, for attaching by screwing, clipping, or being physically combined (such as melded) to the arm. In preferred embodiments, the arm 106 and the flexible arm 105 are between 6 to 9 inches, respectively, in length.

A base extension 108 attaches to the base member 102. The base member is of a height sufficient for placement and use on a table or the floor. In a preferred embodiment, the base extension 108 for placement on the floor is approximately 70 inches in total height. In this preferred embodiment, shown, the base extension 108 may include a slide connection 109, the slide connection 109 is capable of connecting to separate elongated members of the base extension 108 and may be tightened so as to hold the two separate members together. In this way the base extension 108 is height adjustable. The base extension can also include a base support 110 for holding the vanity mirror perpendicular to its support surface. The base support 110 of a preferred embodiment is 1 inch in height and 9.5 inches diameter. The top elongated member in one embodiment is 57.5 inches and the bottom elongated member is 15 inches. A preferably total height of a table supported vanity mirror is 30 inches, the size of other parts may be reduced as well.

In one preferred instance, the light source 103 is delivered a power by a wire running through the vanity mirror. In this preferred instance, the flexible-arm 105, the base member 102, and the base extension 108, can be sufficiently hollow so as to allow the wire to pass therethrough to the light source 103. The base extension 108 may further include a entrance point 601 for a wire to enter through the bottom of the structure. The base member 102 may include a switch 301 for powering on and off the light source 103.

The present invention can be formed out of a variety of material including metal and hard plastics or other sturdy materials. Mirrors can be made out of a variety of material including glass, acrylic, polycarbonate, or other reflective material. Bendable arms with substantial pliability may be constructed out of a combination of metals, or plastics.

While the invention has been described in detail with specific reference to embodiments thereof, it is understood that variations and modifications thereof is made without departing from the true spirit and scope of the invention.

What is claimed is:

1. A mirror for personal care comprising:
a circular mirror; an arm attached to the mirror; a base member, wherein the arm is attached to the base member, wherein the arm attached to the mirror is a first substantially pliable arm; a light socket and a single light source, wherein the single light source is a rounded bulb; a power source attaching to single light source through the light socket; a second substantially pliable arm attached to the light socket, wherein the second substantially pliable arm is attached to the base member and a base extension attached to the base member.

2. The mirror for personal care of claim 1 wherein the base extension comprises: a top elongated member; a bottom elongated member; a slide connection for attaching the top elongated member and the bottom elongated member.

3. (canceled)

4. The mirror for personal care of claim 1 wherein a third flexible-arm attaches a second light socket to the base member.

5. The mirror for personal care of claim 1 wherein flexible-arm, the base member, and the base extension are sufficiently hollow allowing for a power source pass through to the light source.

6. The mirror for personal care of claim 1 wherein the flexible-arm bends at least 220 degrees at its midpoint.

7. The mirror for personal care of claim 1 wherein the flexible-arm bends at least 180 degrees at its midpoint.

8. The mirror for personal care of claim 1 wherein the flexible-arm bends at least 180 degrees at a point halfway between its midpoint and end.

9. The mirror for personal care of claim 1 wherein the flexible-arm bends at least 120 degrees at a point halfway between its midpoint and end.

10-15. (canceled)
